(19) United States
(12) Patent Application Publication
(10) Pub. No.: US 2006/0012832 A1
(43) Pub. Date: Jan. 19, 2006

(54) Printer unit and electronic camera

(75) Inventor: Yasunobu Kayanuma, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/179,582

(22) Filed: Jul. 13, 2005

(30) Foreign Application Priority Data
Jul. 14, 2004 (JP) 2004-207497

(51) Int. Cl. G06K 15/00

(52) U.S. Cl. 358/296

(57) ABSTRACT

The present invention provides a printer unit which has a display unit in a unit body, prints an image displayed on the display unit on a recording sheet at a print directive, and ejects a printed image through an outlet, the printer unit comprising a display posture detection device which detects a posture of the display unit in a gravity direction, a posture information read device which reads posture information added to an image to be displayed on the display unit, and a display control device which controls a vertical direction of an image displayed on the display unit so as to match the gravity direction according to the posture information about the display unit detected by the display posture detection device and the posture information about the image read by the posture information read device.

### BACKGROUND OF THE INVENTION

1. Field of the Invention

The present invention relates to a printer unit and an electronic camera, and more specifically to a printer unit for use as incorporated into a digital camera, a mobile telephone, etc. and an electronic camera provided with the printer unit.

2. Description of the Related Art

An electronic camera which records an image as digital data is provided with a monitor in the camera body so that a taken image can be immediately confirmed. Recently, with the widespread use of electronic cameras, those with a built-in printer have been proposed in various types (for example, Japanese Patent Application Laid-open No. 10-13844, Japanese Patent Application Laid-open No. 11-164185, Japanese Patent Application Laid-open No. 2001-232896, and Japanese Patent Application Laid-open No. 2001-232909).

### SUMMARY OF THE INVENTION

In these cameras with a built-in printer, a monitor provided in a camera body is typically used to determine an image to be printed and issue a print instruction. However, in a conventional camera with a built-in printer, since the print recording surface from a camera does not match the display surface of a monitor provided in the camera body, it is troublesome to confirm an output print.

In addition, since the camera with a built-in printer is small and lightweight, it can be used as held in hand, and the posture is not always fixed. Therefore, an image displayed on the monitor can be inverted or turned depending on the holding in hand, making it difficult to confirm the image. . The present invention has been made in view of such problems, and aims at providing a printer unit and an electronic camera capable of easily confirming an image.

To attain the above-mentioned advantage, the first aspect of the present invention is a printer unit which has a display unit in a unit body, prints an image displayed on the display unit on a recording sheet at a print directive, and ejects a printed image through an outlet, and includes: a display posture detection device which detects a posture of the display unit in the gravity direction; a posture information read device which reads posture information added to an image to be displayed on the display unit; and a display control device which controls the vertical direction of an image displayed on the display unit so as to match the gravity direction according to the posture information about the display unit detected by the display posture detection device and the posture information about the image read by the posture information read device.

According to the first aspect of the present invention, when the display unit displays an image, the image is displayed on the display unit such that the vertical direction of the image matches the gravity direction independent of the posture of the display unit.

To attain the above-mentioned advantage, the second aspect of the present invention provides the printer unit based on the first aspect, and the recording sheet is ejected through the outlet such that the recording surface of the recording sheet on which the image is printed can be parallel to the display surface of the display unit and the recording surface of the recording sheet can be in the same direction of the display surface of the display unit.

According to the second aspect, the recording surface of the recording sheet on which the image is printed can be parallel to the display surface of the display unit, and the recording surface of the recording sheet can be in the same direction of the display surface of the display unit. Thus, the image displayed on the display unit and the printed image can be easily confirmed.

In addition, to attain the above-mentioned advantage, the third aspect of the present invention provides the printer unit based on the second aspect, and the display control device switches display such that the vertical direction of the image displayed on the display unit at a print directive matches the vertical direction of the image on the recording sheet ejected through the outlet.

According to the third aspect, when a print directive is issued, the display of the display unit is switched such that the vertical direction of an image displayed on the display unit matches the vertical direction of the image on the recording sheet ejected from the outlet. Thus, the direction of the image displayed on the display unit matches the direction of the image on the recording sheet ejected from the outlet, and the printed image can be quickly confirmed.

To attain the above-mentioned advantage, the fourth aspect of the present invention provides the printer unit based on the first to third aspects, and further includes a shooting posture detection device which is provided in an electronic camera which captures an image using an image pickup device, records the captured image on a storage medium, detects the posture of the image pickup device, and records on the storage medium the captured image with the posture information about the image pickup device detected by the shooting posture detection device.

According to the fourth aspect, the printer unit based on the first to third aspect is provided in an electronic camera. The electronic camera is provided with a shooting posture detection device which detects the posture of an image pickup device, and records on a storage medium the captured image with the posture information about the image pickup device detected by the shooting posture detection device.

To attain the above-mentioned advantage, the fifth aspect of the present invention provides an electronic camera which captures an image using an image pickup device and records the captured image on a storage medium, the electronic camera comprising a shooting posture detection device which detects a posture of the image pickup device, and a printer unit according to the first to third aspect, wherein the captured image is recorded on the recording medium with the posture information about the image pickup device detected by the shooting posture detection device and the recorded image is printed by the printer unit.

According to the printer unit and the electronic camera of the present invention, an image displayed on the display unit and a printed image can be easily confirmed.

### BRIEF DESCRIPTION OF THE DRAWINGS

FIG. 1 is a front elevation of a mobile telephone to which the present invention is applied;

FIG. 2 is a rear elevation of a mobile telephone to which the present invention is applied;

FIG. 3 is a sectional view at 3-3 shown in FIG. 1;

FIG. 4 is a block diagram of the electric configuration of a mobile telephone;

FIG. 5 shows the configuration of a posture detection sensor;

FIGS. 6A and 6B show the operation status of the posture detection sensor;

FIGS. 7A and 7B show the operation status of the posture detection sensor;

FIGS. 8A to 8D are explanatory views of the posture when an image is shot using a mobile telephone;

FIGS. 9A to 9D show the display status of the image to a normal liquid monitor

FIGS. 10A to 10D show the display status of a liquid crystal monitor when an image is reproduced;

FIGS. 11A to 11D show the display status of a liquid crystal monitor when an image is reproduced;

FIGS. 12A to 12D show the display status of a liquid crystal monitor when an image is reproduced;

FIGS. 13A and 13B show the display status of a liquid crystal monitor when an image is printed;

FIGS. 14A and 14B show the display status of a liquid crystal monitor when an image is reproduced and printed;

FIGS. 15A and 15B show the display status of a liquid crystal monitor when an image is reproduced and printed;

FIG. 16 is a perspective view of a video camera to which the present invention is applied;

FIG. 17 is a perspective view of a watch to which the present invention is applied; and

FIG. 18 is a perspective view of a camera with a built-in printer to which the present invention is applied.

### DETAILED DESCRIPTION OF THE PREFERRED EMBODIMENTS

The best modes for embodying the printer unit and the electronic camera according to the present invention are explained below by referring to the attached drawings.

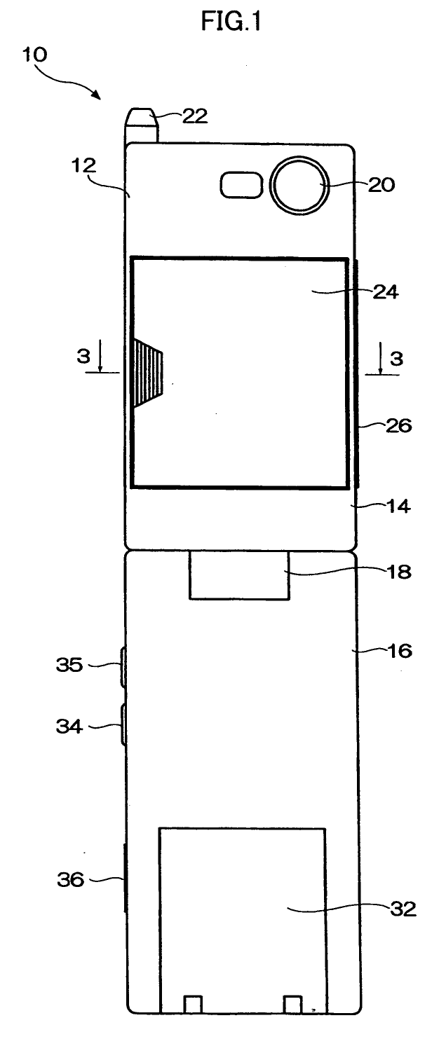

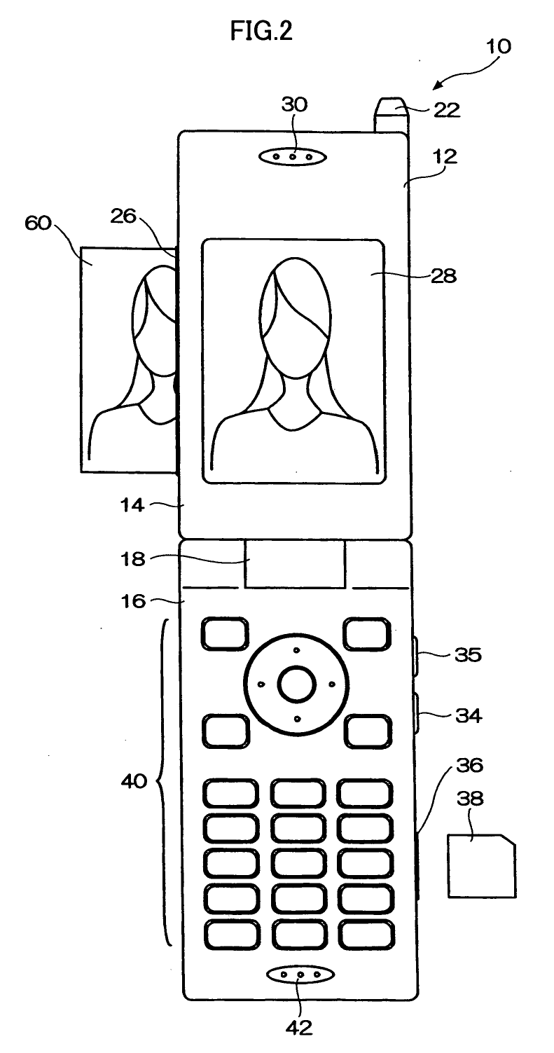

FIGS. 1 and 2 are respectively a front elevation and a rear elevation of a mobile telephone with a camera into which a printer unit and an electronic camera according to the present invention are applied.

As shown in FIGS. 1 and 2, a mobile telephone 10 and a telephone body 13 are configured by a display side housing 14 and an operation side housing 16. The display side housing 14 is coupled with the operation side housing 16 using a hinge 18 as a folding device.

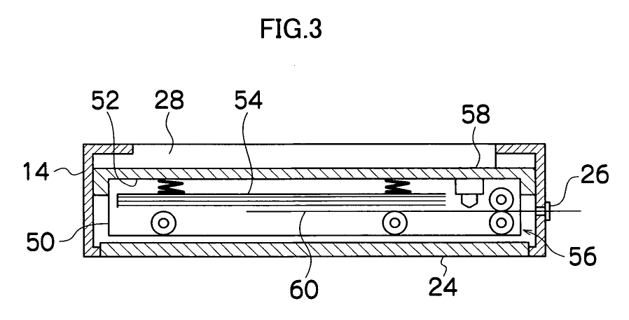

As shown in FIG. 1, a taking lens 20, an antenna 22, and a print unit cover 24 are provided outside the display side housing 14. The taking lens 20 is configured by a short focus lens, and a picture is taken using the taking lens 20. The print unit cover 24 is provided as detachable/attachable to the display side housing 14, and an attachment unit 52 of a printer cartridge 50 described later is provided inside the print unit cover 24 (refer to FIG. 3).

A print outlet 26 is provided on the side of the display side housing 14. Through the print outlet 26 a recording sheet on which an image is printed is ejected.

Inside the display side housing 14, as shown in FIG. 2, a liquid crystal monitor 28 and a receiver 30 are provided. A loudspeaker is mounted inside the receiver 30, and the voice of a communication partner can be output through the loudspeaker.

Outside the operation side housing 16, as shown in FIG. 1, a battery pack 32 is mounted as detachable/attachable.

On the side of the operation side housing 16, a shutter button 34, a print button 35, and a medium slot 36 are provided. A memory card 38 is inserted into the medium slot 36 as detachable/attachable, and captured image data, etc. is recorded on the memory card 38.

As shown in FIG. 2, an operation unit 40 and a transmitter 42 are mounted inside the operation side housing 16. The operation unit 40 is configured by various operation buttons such as a dial button, communication button, a power ON/OFF button, a cross button, etc. Each button is assigned various functions depending on the available mode. A microphone is mounted inside the transmitter 42. The microphone catches the voice of a user.

FIG. 3 is a sectional view at 3-3 shown in FIG. 1, and shows the configuration of the attachment unit 52 of the printer cartridge 50.

As shown in FIG. 3, the attachment unit 52 of the printer cartridge 50 is mounted inside the print unit cover 24.

The printer cartridge 50 is a unit which prints an image in an inkjet system on the recording surface of a predetermined recording sheet, and is provided as detachable/attachable to the 52. The printer cartridge 50 is provided with a recording sheet tray 54, a recording sheet feed mechanism 56, a head 58, and an ink tank (not shown in the attached drawings) as shown in FIG. 3.

The recording sheet tray 54 has a plurality of layered recording sheets 60. The recording sheets 60 have the same aspect ratio as the liquid crystal monitor 28, and their recording surfaces are parallel to and placed in the recording sheet tray 54 in the same direction as the display surface of the liquid crystal monitor 28.

The recording sheet feed mechanism 56 is configured by a plurality of conveying roller, etc. driven by a motor not shown in the attached drawings and rolling so that the recording sheets 60 set on the recording sheet tray 54 can be fed sheet by sheet to the head 58.

The head 58 prints an image using ink of four colors, that is, Y (yellow), M (magenta), C (cyan), and B (black) stored in the ink tank on the recording surface of the recording sheets 60 fed by the recording sheet feed mechanism 56.

The recording sheet 60 on which an image is printed is fed by the recording sheet feed mechanism 56 with the posture kept parallel to the display surface of the liquid crystal monitor 28, and ejected through the print outlet 26. At this time, as shown in FIG. 2, the recording surface of the recording sheet 60 on which an image is printed is placed in the same direction as the display surface of the liquid crystal monitor 28, and ejected through the print outlet 26.

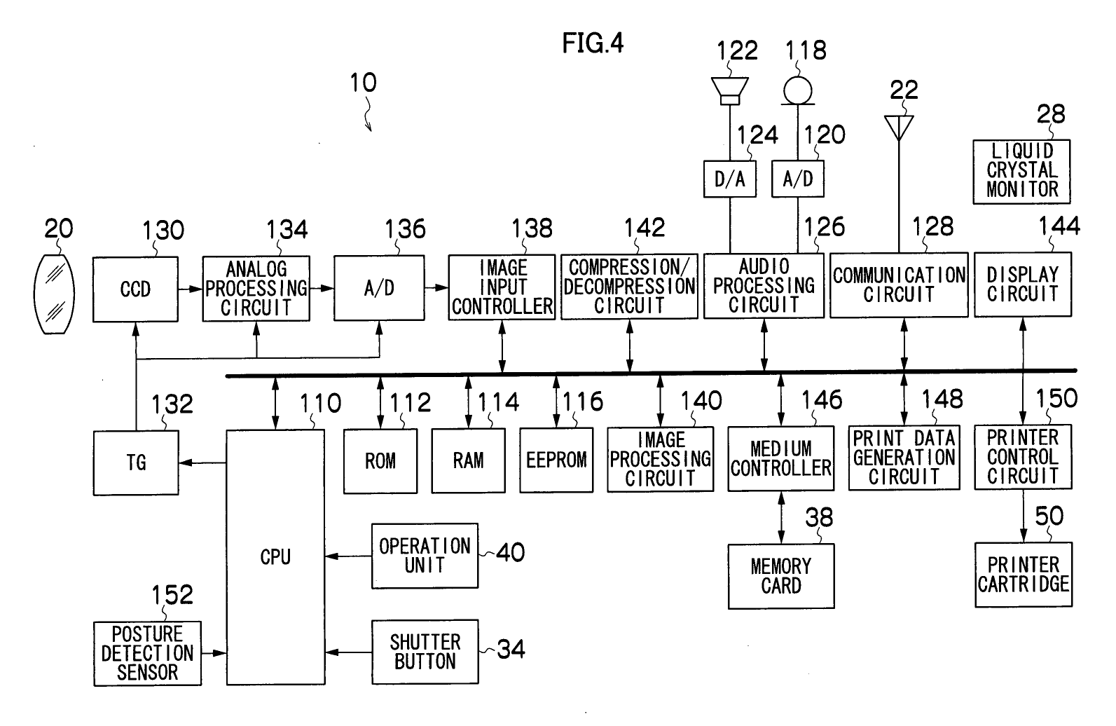

FIG. 4 is a block diagram of the electric configuration of a mobile telephone. As shown in FIG. 4, in addition to the components for providing a telephone facility such as a central processing unit (CPU) 110, ROM 112, RAM 114, EEPROM 116, a microphone 118, an A/D converter 120, a loudspeaker 122, a D/A converter 124, an audio processing circuit 126, a communication circuit 128, etc., the mobile telephone 10 further includes components for providing the functions of an electronic camera such as a CCD 130, a timing generator (TA) 132, an analog processing circuit 134, an A/D converter 136, an image input controller 138, an image processing circuit 140, a compression/decompression circuit 142, a display circuit 144, a medium controller 146, etc., and components for providing the functions of a printer such as a print data generation circuit 148, a printer control circuit 150, etc. The mobile telephone 10 is further provided with a posture detection sensor 152 which detects the posture (=the postures of the liquid crystal monitor 28 and the CCD 130) of the telephone body 12 in the gravity direction.

The functions relating to a telephone are explained below. As described above, the telephone unit is configured mainly by the CPU 110, the ROM 112, the 113, the EEPROM 116, the microphone 118 the A/D converter 120, the loudspeaker 122, the D/A converter 124, the audio processing circuit 126, the communication circuit 128, etc.

The CPU 110 functions as a control unit which integrally controls the operations of the entire mobile telephone, uses the RAM 114 as a work area, and controls each circuit in a mobile telephone according to a predetermined control program. The ROM 112 stores a program executed by the CPU 110 and various data required for control. The EEPROM 116 stores data such as the telephone number of the mobile telephone 10, user-set information, etc.

The microphone 118 is provided inside the transmitter 42. An analog audio signal input through the microphone 118 is converted to a digital audio signal by the A/D converter 120, and input to the audio processing circuit 126.

The audio processing circuit 126 processes the digital audio signal input by the A/D converter 120 under the control of the CPU 110, and converts it to audio data in a predetermined format. The audio processing circuit 126 processes predetermined audio data and generates a digital audio signal output from the loudspeaker 122.

The digital audio signal generated by the audio processing circuit 126 is converted to an analog audio signal by the D/A converter 124, added to the loudspeaker 122 provided inside the receiver 30, and output as voice from the loudspeaker 122.

The communication circuit 128 performs a coding process of transmitting data through the antenna 22 under the control of the CPU 110, and performs a decoding process on data received through the antenna 22.

With the above-mentioned configuration, when a connection to a communication partner is established, an audio signal input through the microphone 118 is input to the audio processing circuit 126 through the A/D converter 120. The audio signal input to the audio processing circuit 126 is treated in predetermined signal processing by the audio processing circuit 126, and then transmitted to a base station from the antenna 22 through the communication circuit 128.

A signal issued from the base station is received by the antenna 22, demodulated by the communication circuit 128, and input to the audio processing circuit 126. The audio data input to the audio processing circuit 126 is treated in predetermined signal processing by the audio processing circuit 126, converted to an analog audio signal by the D/A converter 124, and output through the loudspeaker 122.

Described below are the functions of a camera. As described above, a camera unit is configured mainly by the CCD 130, the timing generator (TA) 132, the analog processing circuit 134, the A/D converter 136, the image input controller 138, the image processing circuit 140, the compression/decompression circuit 142, the display circuit 144, the medium controller 146, etc.

Relating to the entire operations, the CPU 110 integrally controls the operations as in the telephone unit. The CPU 110 uses the RAM 114 as a work area, and controls each circuit according to a predetermined control program stored in the ROM 112.

The CCD 130 is arranged behind the taking lens 20, and its photoreceiving surface has a number of photosensors (photoreceiving device) in two dimensions. The light passing through the taking lens 20 is converted to a signal charge of an amount depending on the quantity of incident light by each photosensor.

The timing generator (TG) 132 generates a timing signal for driving the CCD 130 at a command from the CPU 110. The CCD 130 outputs a signal charge accumulated in each photodiode as a voltage signal (image signal) according to a timing signal applied from the timing generator (TG) 132.

The analog processing circuit 134 performs a correlation duplex sampling process on the image signal sequentially output from the CCD 130.

The A/D converter 136 converts analog image signals of R, G, and B output from the analog processing circuit 134 to the respective digital image signals.

The image input controller 138 accumulates the image signals for one image input from the A/D converter 136, and stores them in the RAM 114 under the control of the CPU 110.

The image processing circuit 140 generates image data by performing predetermined signal processing on the input digital image signal under the control of the CPU 110.

The compression/decompression circuit 142 performs a compressing process on the input image data, generates compressed image data in a predetermined format, performs a decompressing process on the input compressed image data, and generates uncompressed digital image data under the control of the CPU 110.

The medium controller 146 performs read and write control of data on the memory card 38 inserted into the medium slot 36 under the control of the CPU 110.

The display circuit 144 generates a signal from input image data for display of an image indicated by the image data on the liquid crystal monitor 28 under the control of the CPU 110.

With the above-mentioned configuration, the mobile telephone 10 can shoot an image by entering the shooting mode.

A shooting operation can be performed by pressing the shutter button 34. When the shutter button 34 is pressed, the CCD 130 is exposed based on a predetermined stop value and a shutter speed. An image signal output from the CCD 130 is fetched to the image input controller 138 through the analog processing circuit 134 and the A/D converter 136, and stored in the RAM 114. An image signal stored in the RAM 114 is converted to image data by the image processing circuit 140, applied to the compression/decompression circuit 142, and compressed in a predetermined compression format (for example, JPEG). Then, it is recorded on the memory card 38 through the medium controller 146 as an image file (for example, Exif) in a predetermined recording format.

At this time, the posture information (=posture information about the CCD 130 =posture information about the image) at the shooting time of the telephone body 12 detected by the posture detection sensor 152 is recorded with the image data in the image file (for example, recorded in the tag format in the header portion of an image file).

During the shooting operation, images (through images) continuously captured by the CCD 130 are displayed on the liquid crystal monitor 28, and the user adjusts the angle of view, etc. while watching the through image displayed on the liquid crystal monitor 28.

The image file recorded on the memory card 38 is read from the memory card 38 depending on the file selecting operation of a user, and reproduced on the liquid crystal monitor 28. That is, when a user selects an image file to be reproduced, the compressed image data of the image file is read from the memory card 38, and applied to the compression/decompression circuit 142. The compression/decompression circuit 142 performs a predetermined decompressing process on the input compressed image data and applies the resultant data to the display circuit 144. The display circuit 144 converts the input image data to data in the display signal format, and outputs the converted data to the liquid crystal monitor 28. Thus, the image of the selected image file is reproduced and displayed on the liquid crystal monitor 28.

The display on the liquid crystal monitor 28 is performed by appropriately making a turn depending on the operation status and posture of the mobile telephone 10. The display aspect of the liquid crystal monitor 28 is described later.

Described below is the function relating to the printer. As described above, the printer unit is mainly configured by the print data generation circuit 148 and the printer control circuit 150.

Relating to the entire operation, the CPU 110 integrally controls a printer as with a telephone unit and a camera unit. The CPU 110 uses the RAM 114 as a work area, and controls each circuit based on a predetermined control program stored in the ROM 112.

The print data generation circuit 148 generates print data to be printed on the printer cartridge 50 from input image data under the control of the CPU 110.

The printer control circuit 150 controls the drive of the head 58 and the recording sheet feed mechanism 56 of the printer cartridge 50 under the control of the CPU 110, and prints a predetermined image on the recording sheet 60.

A print directive is executed by pressing the print button 35 during the regeneration of an image. When the print button 35 is pressed, the image data being reproduced is added to the print data generation circuit 148, thereby generating print data. The CPU 110 controls the printer cartridge 50 through the printer control circuit 150 based on the generated print data, and the image displayed on the liquid crystal monitor 28 is printed on the recording sheet 60.

Described below is the configuration of the posture detection sensor 152 for detection of the posture of the telephone body 12.

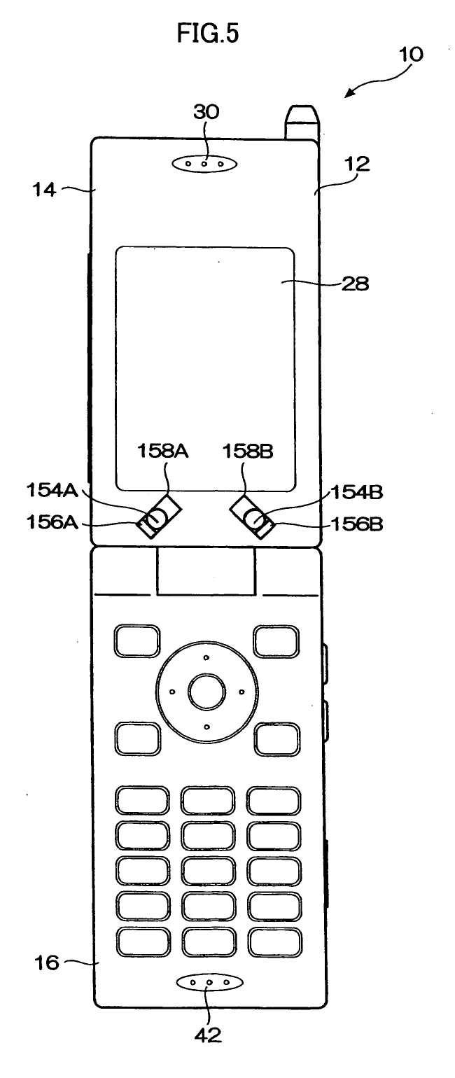

The posture detection sensor 152 is arranged inside the display side housing 14 as shown in FIG. 5, and is configured by a pair of hard balls 154A and 154B and a pair of touch sensors 156A and 156B.

The pair of hard balls 154A and 154B are arranged to be freely moved in cylinders 158A and 158B arranged inside the display side housing 14. Each of the cylinders 158A and 158B is arranged to be inclined at 45°.

The pair of touch sensors 156A and 156B are respectively attached to the bottoms of the cylinders 158A and 158B and are turned on when the pair of hard balls 154A and 154B respectively touch them. The CPU 110 determines the posture of the telephone body 12 based on the output of the pair of touch sensors 156A and 156B.

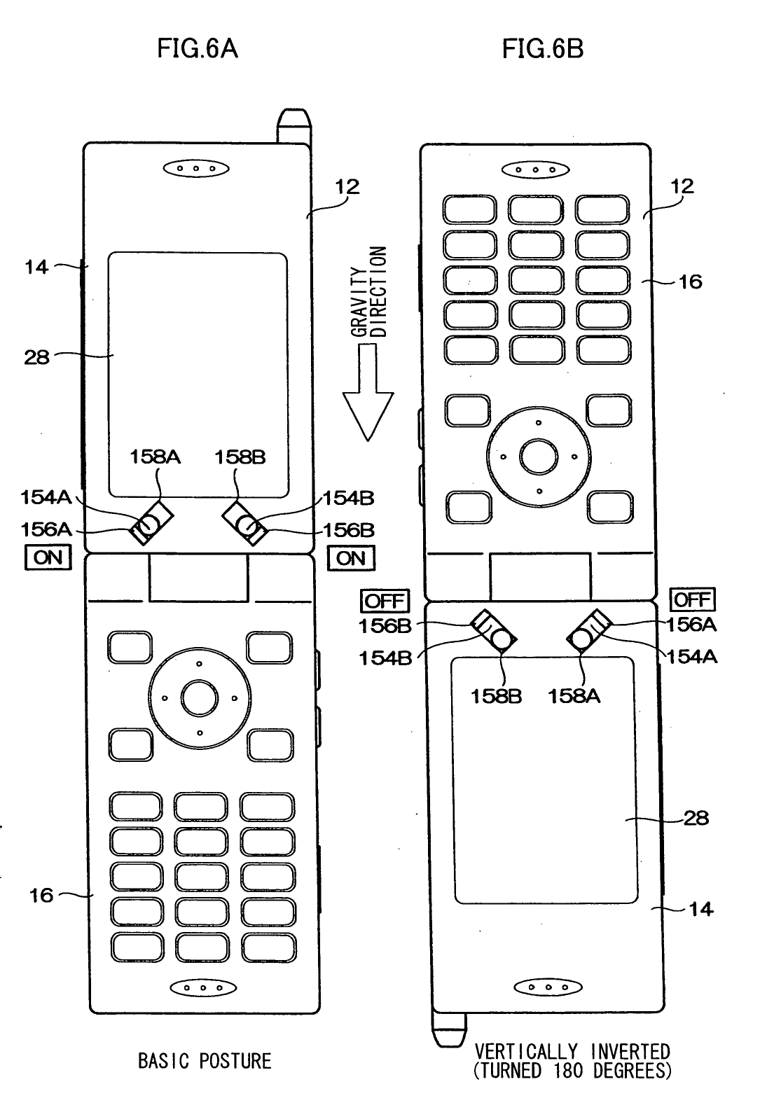

That is, for example, as shown in FIG. 6A, assume that the vertical direction of the telephone body 12 matches the gravity direction (hereinafter, the posture of the telephone body 12 at this time is referred to as a basic posture). In this case, the sensor outputs of the touch sensors 156A and 156B are turned on. Therefore, when the sensor outputs of the touch sensors 156A and 156B are ON, it is determined that the telephone body 12 takes the basic posture.

As shown in FIG. 6B, assume that the telephone body 12 is turned 180 degrees from the basic posture, and the telephone body 12 is inverted about the gravity direction. In this case, the sensor outputs of the touch sensors 156A and 156B are OFF. Therefore, when the sensor outputs of the touch sensors 156A and 156B are OFF, it is determined that the telephone body 12 has made a 180° turn from the basic posture, that is, the telephone body 12 is inverted about the gravity direction.

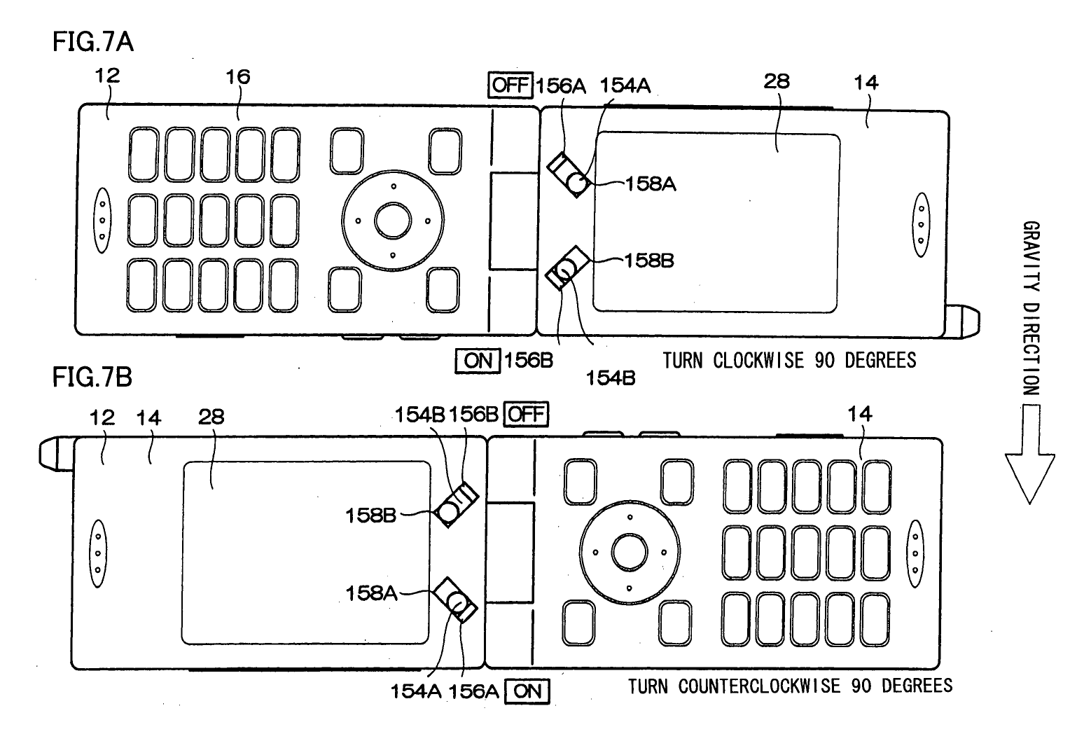

As shown in FIG. 7A, assume that the telephone body 12 is turned clockwise 90 degrees from the basic posture. In this case, the sensor output of the touch sensor 156A is OFF, and the sensor output of the other touch sensor 156B is ON. Therefore, when the sensor output of the touch sensor 156A is OFF and the sensor output of the touch sensor 156B is ON, it is determined that the telephone body 12 is turned clockwise 90 degrees from the basic posture.

As shown in FIG. 7B, assume that the telephone body 12 is turned counterclockwise 90 degrees from the basic posture. In this case, the sensor output of the touch sensor 156A is ON, and the sensor output of the other touch sensor 156B is OFF. Therefore, when the sensor output of the touch sensor 156A is ON and the sensor output of the touch sensor 156B is OFF, it is determined that the telephone body 12 is turned counterclockwise 90 degrees from the basic posture.

Thus, the CPU 110 determines the posture of the telephone body 12 about the gravity direction based on the outputs of the touch sensors 156A and 156B, and controls the display of the liquid crystal monitor 28 according to the detected posture information.

The CCD 130 which captures an image and the liquid crystal monitor 28 which displays the image are provided in the display side housing 14 of the same telephone body 12 in the mobile telephone 10 in the present embodiment. Therefore, if the posture of the telephone body 12 (display side housing 14) is detected, the posture of the CCD 130 and the liquid crystal monitor 28 is detected. In this case, the sensor (shooting posture detection sensor) for detecting the posture of the CCD 130 and the sensor (display posture detection sensor) for detecting the posture of the liquid crystal monitor 28 are shared.

Described below is the display aspect of the liquid crystal monitor 28 depending on the posture of the telephone body 12.

As described above, an image file recorded on the memory card 38 is read from the memory card 38 depending on the file selecting operation of a user, and is reproduced on the liquid crystal monitor 28.

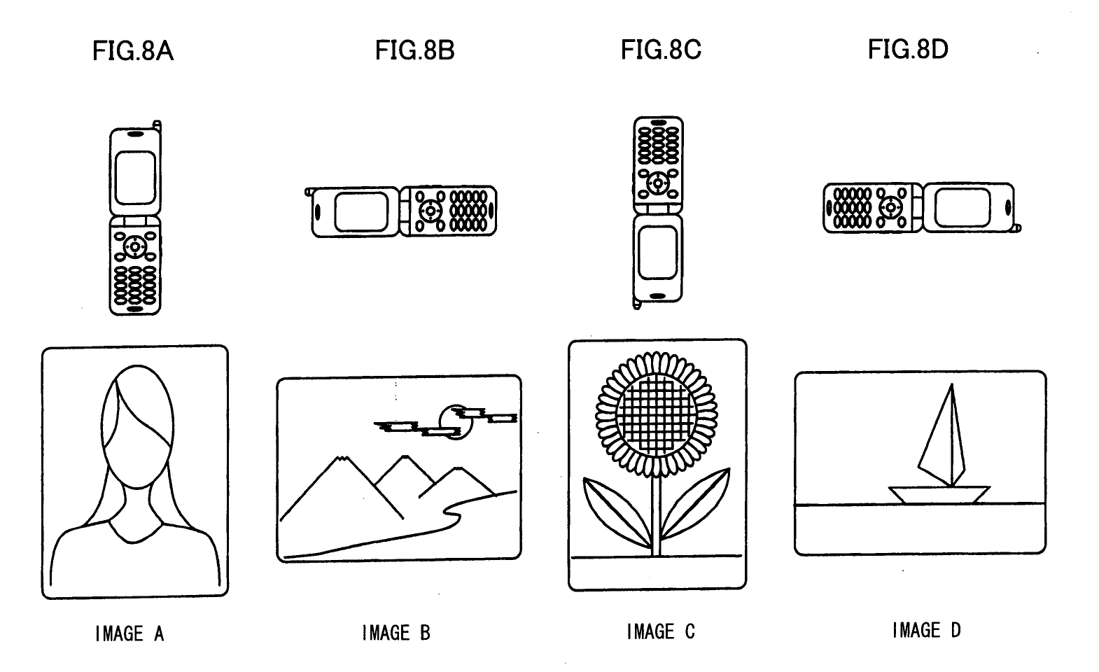

Assume that, as shown in FIGS. 8A to 8D, the memory card 38 records an image file of four images, that is, an image (image A) shot as the basic posture of the telephone body 12, an image (image B) shot as turned counterclockwise 90 degrees from the basic posture, an image (image C) shot as turned 180 degrees (inverted about the vertical direction) from the basic posture, and an image (image D) shot as turned clockwise 90 degrees from the basic posture.

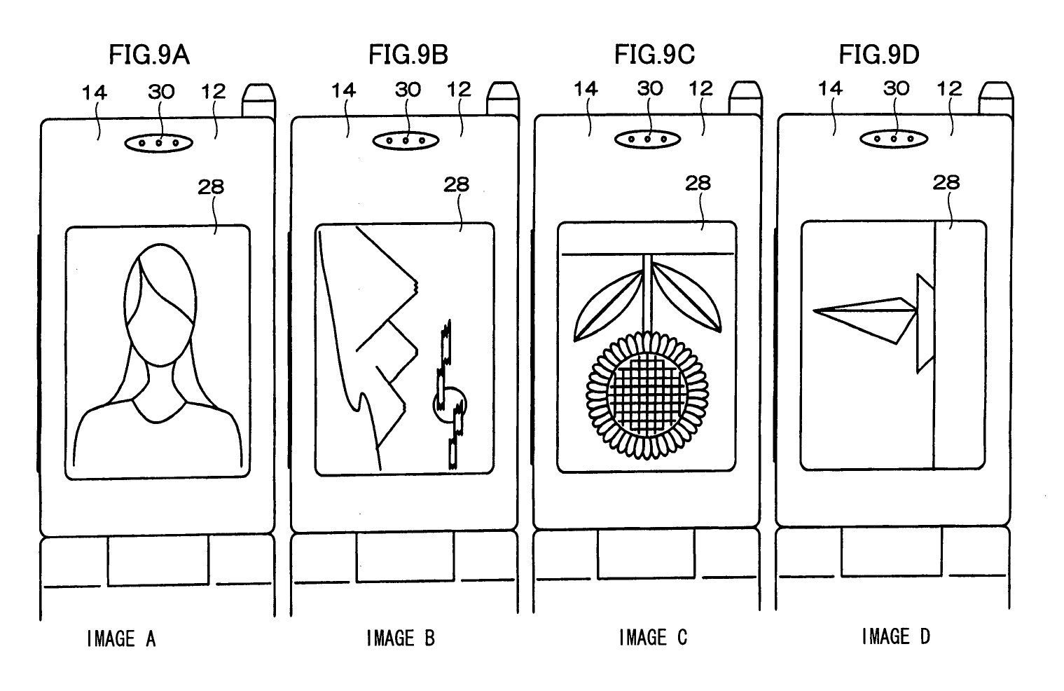

Normally, when each image file is reproduced, an image is reproduced and displayed on the liquid crystal monitor 28 in the same status as the display on the liquid crystal monitor 28 when the image is shot. Therefore, when each image file is reproduced in the basic posture of the telephone body 12, only the image (image A) shot when the telephone body 12 takes the basic posture is displayed on the liquid crystal monitor 28 with the vertical direction matching the gravity direction as shown in FIGS. 9A to 9D. Similarly when each image file is reproduced with the telephone body 12 turned clockwise 90 degrees from the basic posture, only the image (image D) shot as turned clockwise 90 degrees from the basic posture is reproduced and displayed on the liquid crystal monitor 28 with the vertical direction matching the gravity direction.

The above-mentioned display method requires changing the direction of the telephone body 12 and the face of a user depending on the direction of an image to be reproduced, thereby causing poor operability.

Therefore, in the mobile telephone 10 according to the present embodiment, the display of the liquid crystal monitor 28 is controlled such that the vertical direction of the image displayed on the liquid crystal monitor 28 can constantly match the gravity direction according to the posture information (posture information about the telephone body 12 when a shooting operation is performed) about an image attached to the image data and the current posture information about the telephone body 12.

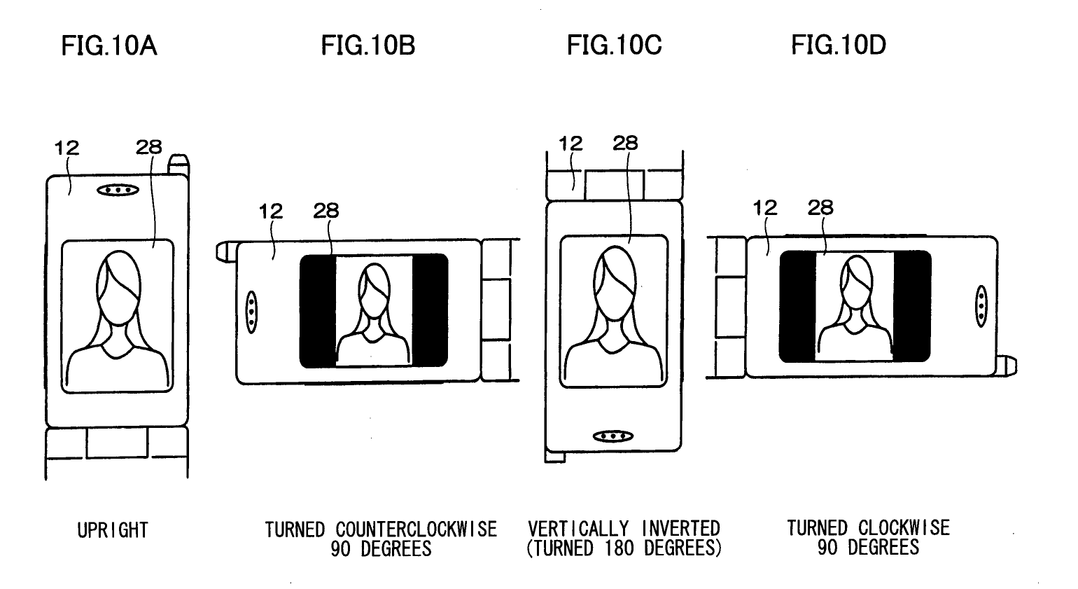

That is, the CPU 110 reads the posture information about the image recorded on each image file when each image file is reproduced, and determines the current posture of the telephone body 12 from the output of the posture detection sensor 152, and controls the display circuit 144 such that the vertical direction of the image displayed on the liquid crystal monitor 28 can constantly match the gravity direction independent of the posture of the telephone body 12 as shown in FIG. 10.

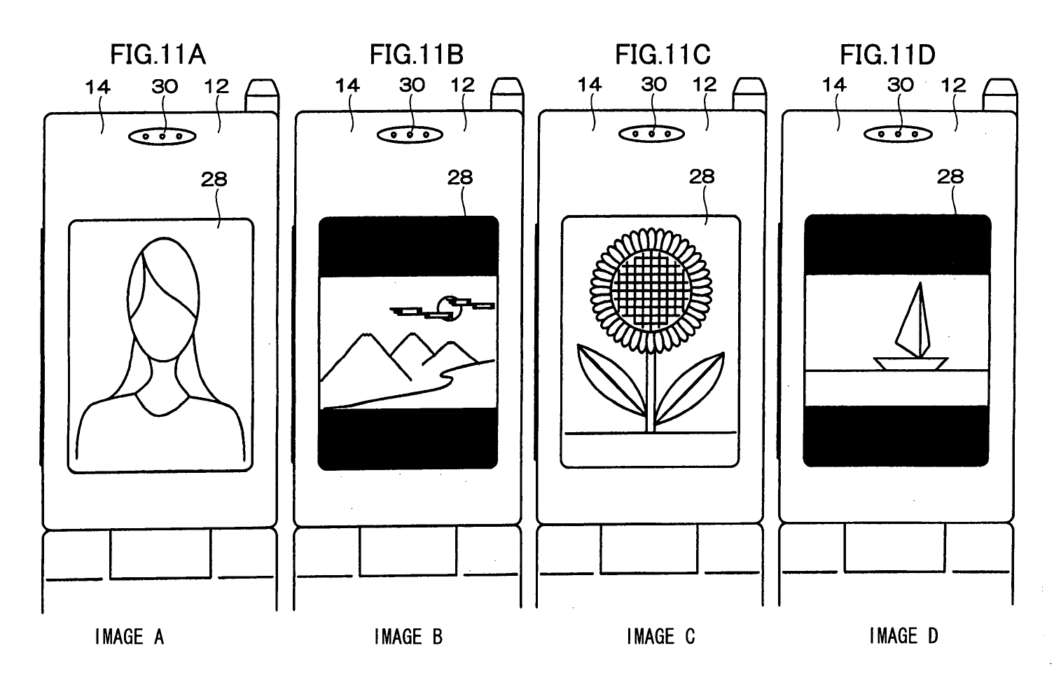

As a result, for example, when each image file is reproduced with the telephone body 12 taking the basic posture, all images are reproduced and displayed on the liquid crystal monitor 28 with the vertical directions matching the gravity direction as shown in FIGS. 11A to 11D.

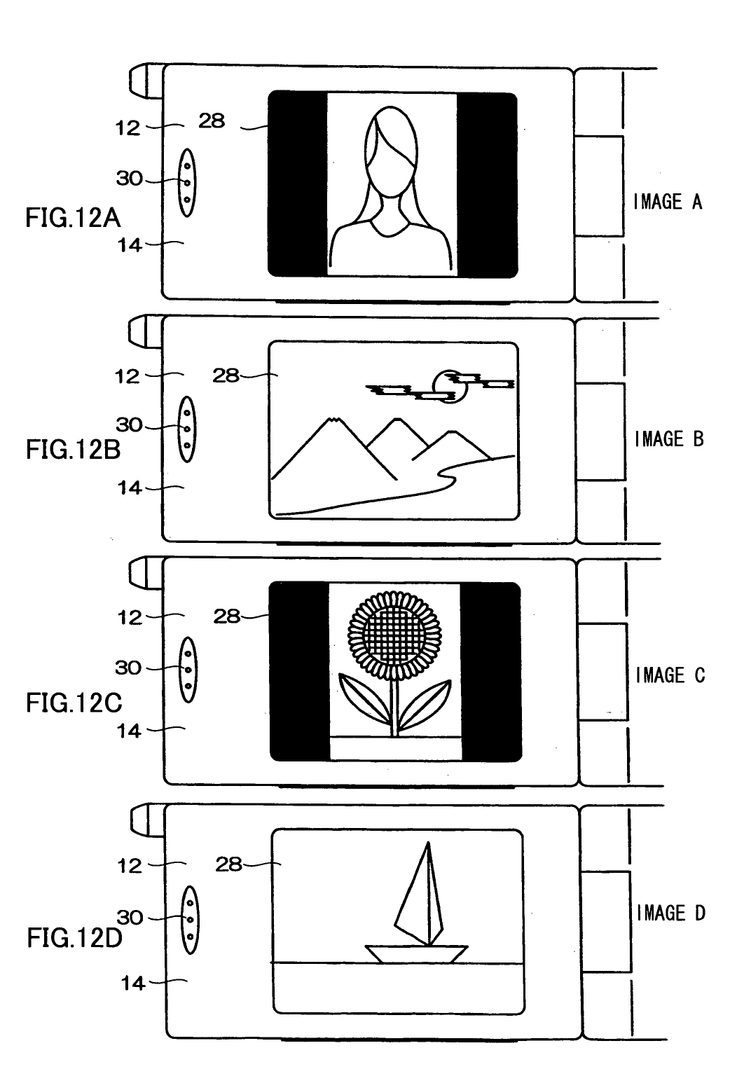

Similarly, when each image file is reproduced with the telephone body 12 turned counterclockwise 90 degrees from the basic posture, all images are reproduced and displayed on the liquid crystal monitor 28 with the vertical directions matching the gravity direction as shown in FIGS. 12A to 12D.

As described above, according to the mobile telephone 10 of the present embodiment, a reproduced image is displayed on the liquid crystal monitor 28 with the vertical direction of the image displayed on the liquid crystal monitor 28 constantly matching the vertical direction. Thus, an image can be appreciated with the same posture without changing the direction of the telephone body 12 depending on the direction of the image when it is shot.

Described above is the display aspect of the liquid crystal monitor 28 when an image is reproduced. When an image is printed, the display of the liquid crystal monitor 28 is switched as followed. That is, when a print directive is issued to an image being reproduced, the display is switched such that the vertical direction of the image to be displayed on the liquid crystal monitor 28 can matches the vertical direction of the image on the recording sheet to be ejected through the print outlet 26.

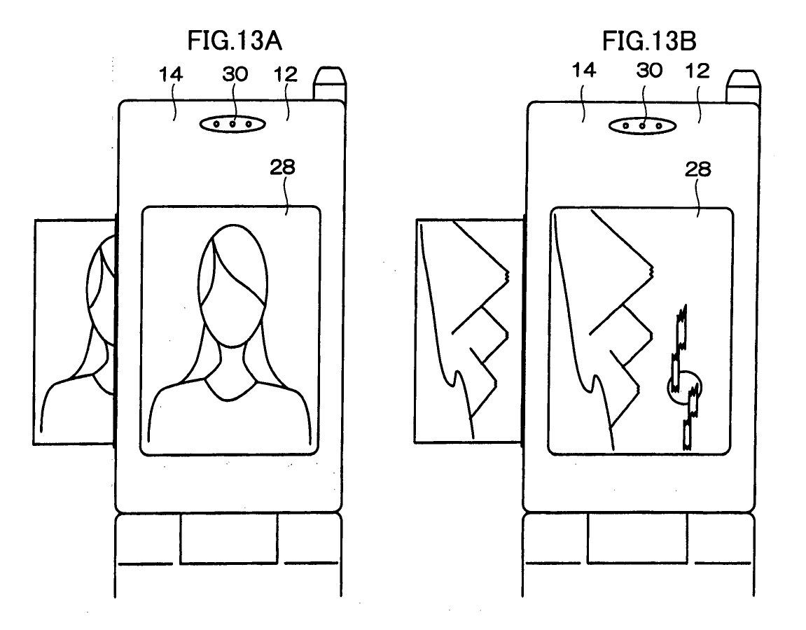

In the mobile telephone 10 according to the present embodiment, the image printed on the recording sheet 60 is recorded on the recording sheet in the same direction of the image displayed on the liquid crystal monitor 28 when the image is shot as shown in FIGS. 13A and 13B. Therefore, when a print directive is issued, the display status is switched to the direction when the image is shot.

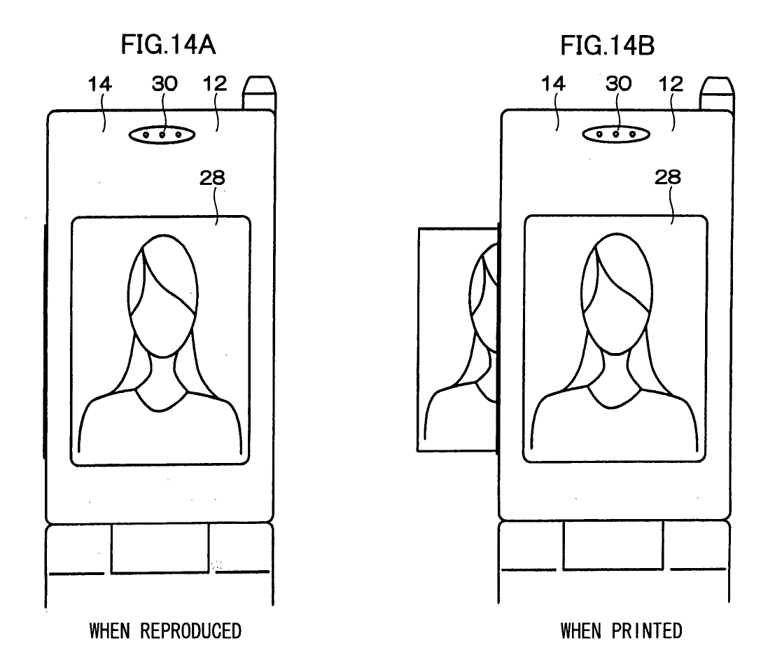

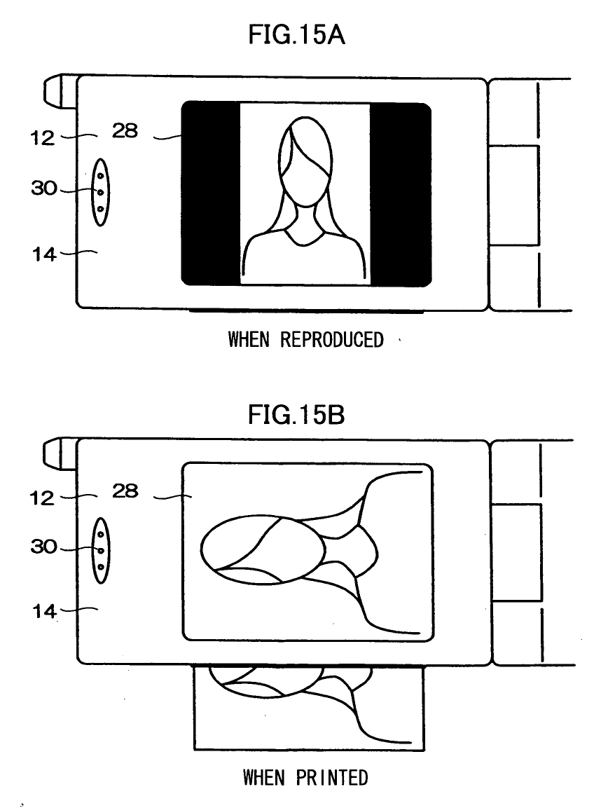

Therefore, for example, although a print directive is issued when the image shot with the basic posture is reproduced with the basic posture as shown in FIG. 14A, the display on the liquid crystal monitor 28 is not switched as shown in FIG. 14B. However, when a print directive is issued while the image shot with the basic posture is being reproduced with the image turned counterclockwise 90 degrees from the basic posture as shown in FIG. 15A, the display on the liquid crystal monitor 28 is switched to the display status at the time of the basic posture as shown in FIG. 15B.

Thus, when an image is printed, the display on the liquid crystal monitor 28 is switched such that the vertical direction of the image to be displayed on the liquid crystal monitor 28 can matches the vertical direction of the image on the recording sheet to be ejected through the print outlet 26, thereby quickly and easily confirming the image being printed.

After completing the printing operation, the display on the liquid crystal monitor 28 is switched again such that the vertical direction of the image matches the gravity direction depending on the posture of the telephone body 12.

As explained above, in the mobile telephone 10, the display on the liquid crystal monitor 28 is controlled such that the vertical direction of the image displayed on the liquid crystal monitor 28 can constantly match the gravity direction when the image is reproduced, and the display on the liquid crystal monitor 28 is controlled such that the direction of the image to be displayed on the liquid crystal monitor 28 can matches the direction of the image on the recording sheet to be ejected through the print outlet 26 when the image is printed. Thus, a reproduced image and a printed image can be easily confirmed, thereby successfully providing a convenient mobile telephone 10.

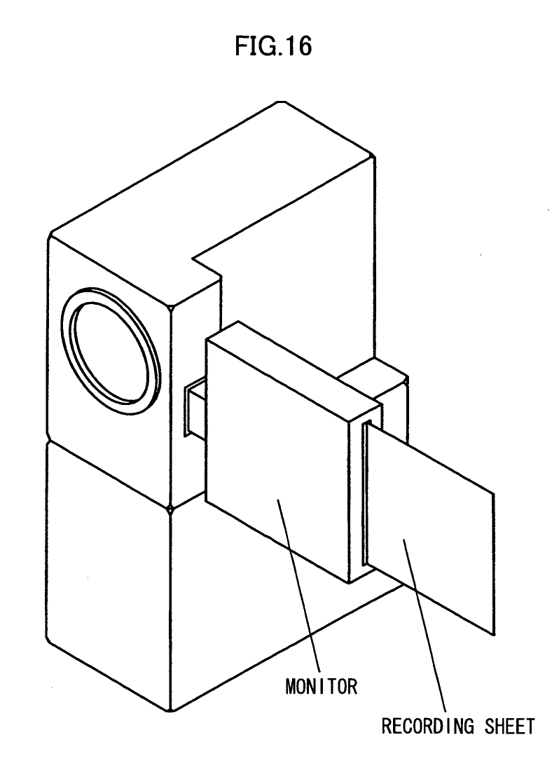

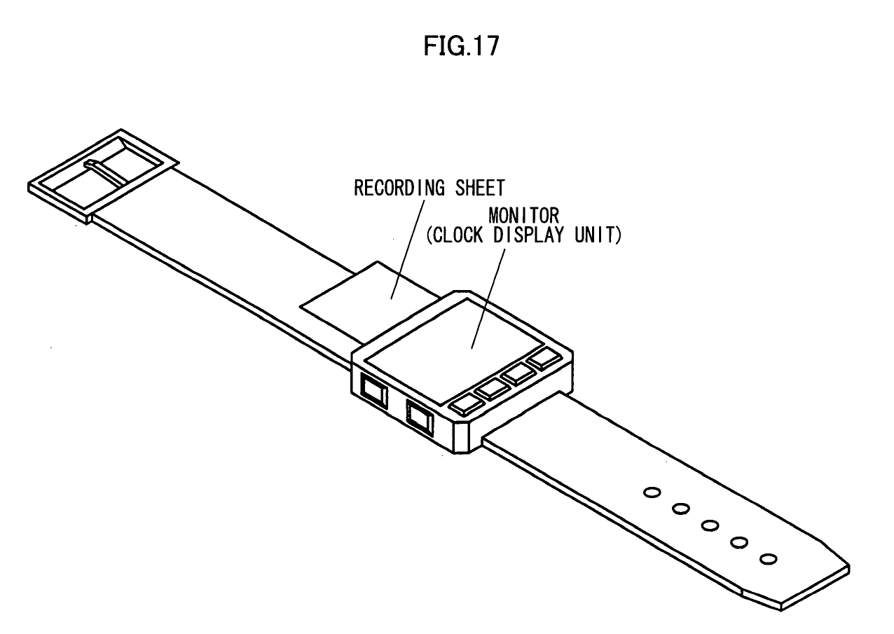

In the present embodiment, the printer unit according to the present invention is explained by referring to an example in which the printer unit is incorporated into a mobile telephone 10 with a camera. However, the present invention is not limited to this application. For example, a single printer can be configured as a mobile printer. As shown in FIG. 16, it can be incorporated into a video camera. In addition, it can be incorporated into a watch as shown in FIG. 17. When the present invention is applied to a video camera, an image printed on a printer is displayed on the monitor which is an image display unit. Furthermore, when the present invention is applied to a watch, the monitor which is a clock display unit can display an image printed on a printer.

In the present embodiment, an inkjet system is applied as a printing system. However, the printing system is not specifically limited to this application. For example, the inkjet system can be replaced with the sublimation type thermal transfer system using an ink ribbon. A thermosensitive system using a thermal paper can also be used. A dot impact system can be used, and a printing system using an instant film containing a developing process liquid can also be adopted.

Although a printing system is changed, the recording surface of the recording sheet on which an image is printed is placed in the same direction as the display screen on the liquid crystal monitor 28, and is ejected through the outlet parallel to the display surface of the liquid crystal monitor 28.

Furthermore, according to the present embodiment, the print outlet 26 is formed on the side of the telephone body 12. When the print outlet 26 is attached, the position is not restricted, and it can be provided on the top surface of the telephone body 12. In this case, the recording surface of the recording sheet faces the same direction as the display surface on the liquid crystal monitor 28 so that sheet can be ejected parallel to the display surface of the liquid crystal monitor 28.

Furthermore, in the present embodiment, the posture detection sensor is configured by a pair of hard balls and a pair of touch sensors. However, the configuration of the posture detection sensor is not limited to this application, but the posture of the telephone body can be detected using a sensor having a different configuration.

Furthermore, according to the present embodiment, the display of the liquid crystal monitor 28 is controlled such that the vertical direction of the image displayed on the liquid crystal monitor 28 can constantly match the gravity direction, but switch can also be made to the normal display status (FIG. 9) at an instruction to switch the display from a user.

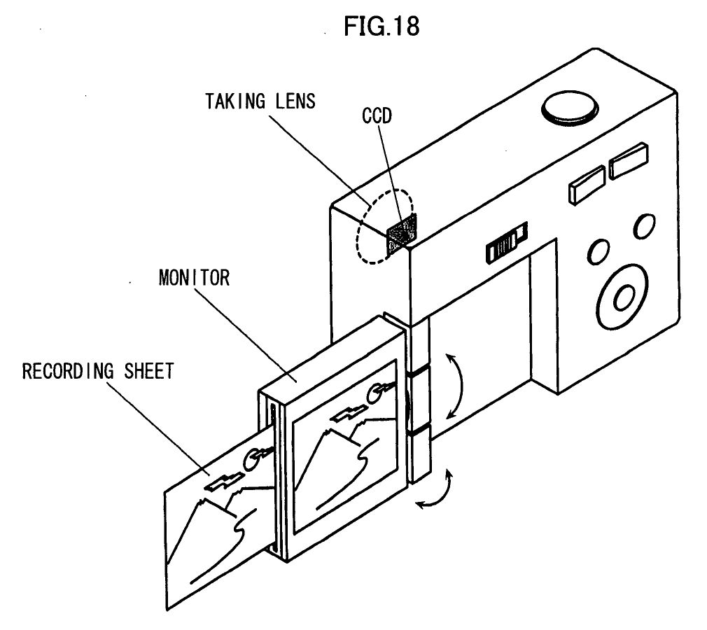

In addition, according to the present embodiment, since the CCD 130 which shoots an image and the liquid crystal monitor 28 on which an image is displayed are mounted on the same display side housing 14 of the telephone body 12. Therefore, the sensor (shooting posture detection sensor) for detecting the posture of the CCD 130 and the sensor (display posture detection sensor) for detecting the posture of the liquid crystal monitor 28 are shared. For example, as shown in FIG. 18, when a monitor is mounted to the device body provided with a taking lens and a CCD to be freely rotated about the horizontal and vertical axes, it is necessary to separately mount the sensor (display posture detection sensor) for detecting the posture of the monitor and the sensor (shooting posture detection sensor) for detecting the posture of the device body (=posture of the CCD). Similarly, when the shooting unit provided with a taking lens and the CCD is mounted to be freely turned about the horizontal and vertical axes against the device body with the monitor, the sensor (shooting posture detection sensor) for detecting the posture of the shooting unit and the sensor (display posture detection sensor) for detecting the posture (posture of the monitor) of the device body are to be separately mounted.

What is claimed is:

1. A printer unit which has a display unit in a unit body, prints an image displayed on the display unit on a recording sheet at a print directive, and ejects a printed image through an outlet, comprising:
a display posture detection device which detects a posture of the display unit in a gravity direction;
a posture information read device which reads posture information added to an image to be displayed on the display unit; and
a display control device which controls a vertical direction of an image displayed on the display unit so as to match the gravity direction according to the posture information about the display unit detected by the display posture detection device and the posture information about the image read by the posture information read device.

2. The printer unit according to claim 1, wherein
the recording sheet is ejected through the outlet such that a recording surface of the recording sheet on which the image is printed can be parallel to a display surface of the display unit and the recording surface of the recording sheet can be in the same direction of the display surface of the display unit.

3. The printer unit according to claim 2, wherein
the display control device switches display such that the vertical direction of the image displayed on the display unit at a print directive matches the vertical direction of the image on the recording sheet ejected through the outlet.

4. The printer unit according to claim 1, further comprising
a shooting posture detection device which is provided in an electronic camera which captures an image using an image pickup device, records the captured image on a storage medium, detects a posture of the image pickup device, and records on the storage medium the captured image with the posture information about the image pickup device detected by the shooting posture detection device.

5. The printer unit according to claim 2, further comprising
a shooting posture detection device which is provided in an electronic camera which captures an image using an image pickup device, records the captured image on a storage medium, detects a posture of the image pickup device, and records on the storage medium the captured image with the posture information about the image pickup device detected by the shooting posture detection device.

6. The printer unit according to claim 3, further comprising
a shooting posture detection device which is provided in an electronic camera which captures an image using an image pickup device, records the captured image on a storage medium, detects a posture of the image pickup device, and records on the storage medium the captured image with the posture information about the image pickup device detected by the shooting posture detection device.

7. An electronic camera which captures an image using an image pickup device and records the captured image on a storage medium, the electronic camera comprising:
a shooting posture detection device which detects a posture of the image pickup device; and
a printer unit according to claim 1, wherein
the captured image is recorded on the recording medium with the posture information about the image pickup device detected by the shooting posture detection device; and
the recorded image is printed by the printer unit.

8. An electronic camera which captures an image using an image pickup device and records the captured image on a storage medium, the electronic camera comprising:
a shooting posture detection device which detects a posture of the image pickup device; and
a printer unit according to claim 2, wherein
the captured image is recorded on the recording medium with the posture information about the image pickup device detected by the shooting posture detection device; and
the recorded image is printed by the printer unit.

9. An electronic camera which captures an image using an image pickup device and records the captured image on a storage medium, the electronic camera comprising:
a shooting posture detection device which detects a posture of the image pickup device; and
a printer unit according to claim 3, wherein
the captured image is recorded on the recording medium with the posture information about the image pickup device detected by the shooting posture detection device; and
the recorded image is printed by the printer unit.
